(19) United States
(12) Patent Application Publication
(10) Pub. No.: US 2015/0233267 A1
(43) Pub. Date: Aug. 20, 2015

(54) LEVER-STYLE CAM FOLLOWER

(71) Applicant: SCHAEFFLER TECHNOLOGIES AG & CO. KG, Herzogenaurach (DE)

(72) Inventor: Stefan Dupke, Kodnitz (DE)

(73) Assignee: Schaeffler Technologies AG & Co. KG, Herzogenaurach (DE)

(21) Appl. No.: 14/431,057

(22) PCT Filed: Jul. 10, 2013
(86) PCT No.: PCT/DE2013/200041

§ 371 Date: Mar. 25, 2015

(30) Foreign Application Priority Data
Oct. 2, 2012 (DE) 10 2012 217 984.4
Oct. 25, 2012 (DE) 10 2012 219 506.8

(51) Int. Cl. F01L 1/18; F16H 53/06

(52) U.S. Cl. CPC F01L 1/185; F16H 53/06

(57) ABSTRACT

A lever-style cam follower (1) is provided for a sliding cam valve train of an internal combustion engine, including a cam roller follower (2), a structure (3) for a gas exchange valve, and a bearing point (4) for support against a cylinder head of the internal combustion engine. This cam follower (1) includes two lateral walls (6) which are connected by a transverse bar (5) and between which the cam roller follower (2) is received, the follower being mounted on a pin (7) that extends in bore holes (9) in the lateral walls (6). Each bore hole (9) intersects, in some sections, a lateral wall (6) longitudinal side (10) that faces the cam such that said pin (7) lies with a peripheral segment (11) exposed on the longitudinal side (10). This therefore allows the height of the lateral walls (6) to be reduced even further, thus permitting a greater cam differential stroke.

### BACKGROUND

The invention relates to a lever-style cam follower, especially for a sliding cam valve train of an internal combustion engine, with a cam roller follower, an structure for a gas exchange valve, and a support point for support against a cylinder head of the internal combustion engine, said cam follower comprising two lateral walls which are connected by a transverse bar and between which the cam roller follower is received, said follower being mounted on a pin that extends into bore holes in the lateral walls.

A cam follower according to this class is disclosed in FIG. 3 of DE 10 2004 002 290 A1. As can be seen, the cam follower, which is provided here as a rocker lever, has a reduced lateral wall height on the side of the deactivated cam profile.

The decisive factor for a maximum differential stroke of the cam to be achieved is the distance between the top side of the cam roller follower and the longitudinal side of the lateral wall facing the cam when the cam is deactivated (2-piece or 3-piece cam package). Increasing the radius of the roller could be used to enable a larger differential stroke. But this would necessarily lead to an increase of the usually required roller pocket in the transverse bar with the result of lower stiffness and increase in the cam follower mass.

As can be further seen from the document cited above, the holes for holding the pin for supporting the cam roller follower are relatively close to the longitudinal sides of the lateral walls facing the cam. A web of residual lateral wall material above each hole is necessary here to prevent, e.g., the needles of the needle bearing for the cam roller follower from falling out in the axial direction and to enable a cleaner, crack-free blocking process.

### SUMMARY

The objective of the invention is to enable, in the cam follower specified above, an increased cam differential stroke without significant loss of stiffness and without increasing the mass.

This objective is met according to the invention in that each hole for the pin intersects, in some sections, a longitudinal side of its lateral wall such that the pin on this longitudinal side is exposed with a peripheral segment.

Thus, in the area of its largely load-free zone, the pin is not surrounded by the material forming the hole. Each lateral wall is reduced in its height for a constant distance of the hole to the longitudinal side facing away from the cam practically so much that the hole moves into the upper longitudinal wall in some sections. This enables an increased differential stroke for the cam pair/cam group. In other words, even for a constant differential stroke, the cam roller follower can be reduced in its diameter, which saves mass and reduces the installation space.

Included in the scope of protection is also a solution in which only one of the pin holes is formed partially open and that is the one on the lever side on which the inactive cam/inactive cam group “dips down” and thus controls the installation space requirements here.

The use of the cam follower that can be provided for a finger follower, rocker arm, or a swing arm and preferably relates to a variable sliding cam valve train. Use in a standard valve train, however, is also conceivable and provided for. Furthermore, an application as a cam follower or eccentric follower in a pump or a compressor is also possible.

According to one advantageous construction of the invention, each hole surrounds the pin by more than 180°, so that this cannot come out of the free peripheral segment after successful installation. However, a U-shaped hole pocket on each lateral wall with parallel legs is also conceivable. Here, an attachment of the pin, e.g., by means of a snap ring-groove connection, a weld spot, a swaged section, or pressing is possible. Alternatively, the pin could also be enclosed by the holes by less than 180°, so that the legs are spread out. In this variant, the pin would eventually sit “loosely” in the holes during the operation of the internal combustion engine and would be blocked from falling out only for transport/handling up to the final installation. However, a position securing device could also be provided for the operation.

In one actual implementation of the invention, the pin is to be held by flexible elastic projections that are made from the lateral wall material surrounding this pin over 180°. Thus, for installation, the pin is snapped into the holes simply by spreading the projections. Another possible installation option for the pin is lateral insertion in a known way with subsequent, end-side swaging. Here, the projections do not have to be bent out.

If is preferred when the pin is completely through-hardened in the longitudinal direction (core hardness at least 58HRC), wherein this pin then undergoes the previously mentioned swaging, e.g., but not exclusively, by means of radial point riveting, in the hard state. The through-hardening requires only comparatively low expense for the heat treatment. The pin can be provided here as a mass-produced article from anti-friction bearing production.

Additional dependent claims relate to preferred bearing options for the cam roller follower on the pin. Here, an anti-friction bearing, such as a needle bearing, is primarily imagined. However, a sliding bearing or a sliding anti-friction bearing is also possible.

Thus, in one refinement of the invention, the cam roller follower is supported by a sliding bearing directly on the pin. Here, someone skilled in the art can design suitable side lubricant inlets and an increased pin diameter within the lateral walls of the cam follower.

Alternatively, the anti-friction bearing could also be eliminated and an intermediate ring could be used instead that could be made, in addition to a steel material, also from a plastic or an engineering ceramic. If necessary, the intermediate ring could also be combined with a needle bearing on its outer raceway or opening.

It is also proposed that the pin has, on both ends, a step in its diameter by means of which it is supported in the holes, wherein ring projections of the steps run in front of the inner sides of the lateral walls, fixing the pin in the axial direction. The centrally raised area could be connected to the pin in one or more parts. For the latter solution, the pin could have a pressed-on ring whose ends form the ring projections. This solution is comparatively economical.

Due to the reduced pin diameter in its end areas noted above, for a constant distance of the holes to the bottom side of the cam follower, the longitudinal sides of the lateral walls facing the cam have an even lower design. Thus, under some circumstances an even larger cam differential stroke is possible or it is possible, with the same differential stroke, to reduce the cam roller follower in diameter.

The invention also provides for an assembly kit principle, i.e., for a pin of equal “thickness,” depending on the application, rings with different outer diameters could be pressed on (needle or sliding bearing), in order, e.g., to reduce the Hertzian contact stress for an increased ring or to create better sliding bearing conditions.

According to another actual implementation of the invention, the cam follower is to have a U-profile in cross section and is to be made using punching, bending techniques from sheet metal. However, an inverted U-profile or an H-shape is also conceivable and provided for. In addition, the cam follower could also be made from several components.

In addition to a sheet metal construction, the cam follower could also be produced in an impact extrusion or metal-cutting method or through casting or in an MIM process.

### BRIEF DESCRIPTION OF THE DRAWINGS

With regard to the drawing:

FIG. 1 shows a first variant of a cam follower formed as a rocker arm with needle-supported cam roller follower in a three-dimensional view,

FIG. 2 shows a cam follower similar to the aforementioned, but with cam roller follower running directly on the pin, and pin snapped into the holes, and

FIG. 3 shows a cam follower as before, but with an intermediate ring for supporting the cam roller follower, here in side view.

### DETAILED DESCRIPTION OF THE PREFERRED EMBODIMENTS

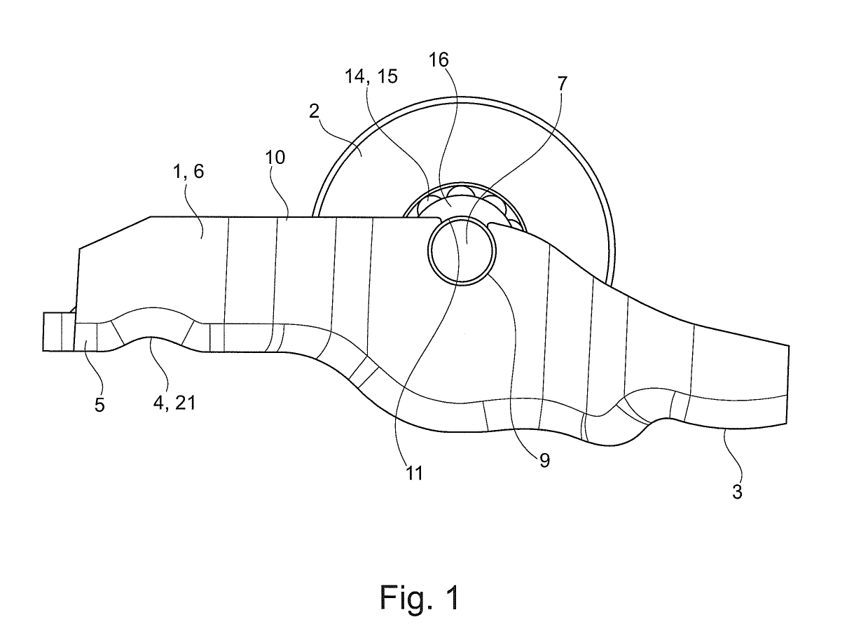

From FIG. 1, a narrow construction, lever-like cam follower 1 for a sliding cam valve train of an internal combustion engine can be seen. The cam follower 1 has a U-shaped cross section and is formed of thin-walled sheet steel.

The cam follower 1 that is here provided as a finger lever has two upright lateral walls 6 connected by one transverse bar 5. On a bottom side 21 of the transverse bar 5 there is, on one end, a contact 3 for a gas exchange valve and, on the other end, a dome-shaped support point 4 for the pivoting support on a head of a support element.

For example, in the area of a longitudinal center of the cam follower 1, a cam roller follower 2 runs between its lateral walls 6 on a pin 7 that sits in holes 9 of the lateral walls 6. As can be seen, the holes 9 are not completely closed, but instead each hole 9 intersects, in some sections, a longitudinal side 10 of its lateral wall 6 facing the cam, so that the pin 7 is exposed on its longitudinal side 10 with a peripheral segment 11. According to all of the figures, each hole 9 surrounds the pin 7 by more than 180°.

As shown in FIG. 1, the cam roller follower 2 sits on the pin 7 via a needle bearing 14. Here, needles 15 of the needle bearing 14 are free of walls laterally in the area of each longitudinal side 10 of the lateral wall 6 facing the cam, i.e., in other words, they project past the longitudinal sides 10 of the lateral walls 6. For their captive arrangement, on both sides of the cam roller follower 2 there is a thrust washer 16 that sits on the pin 7 within the lateral walls 6 and largely covers the needles 15 in the radial direction.

The completely through-hardened pin 7 is swaged on the end sides according to FIG. 1, that is, spread out and thus fixed in the axial direction. If necessary, it can be provided within the holes 9 so that it can rotate, despite its spreading. For the purpose of its installation, it is guided laterally by the holes 9 for a preassembled cam roller follower 2.

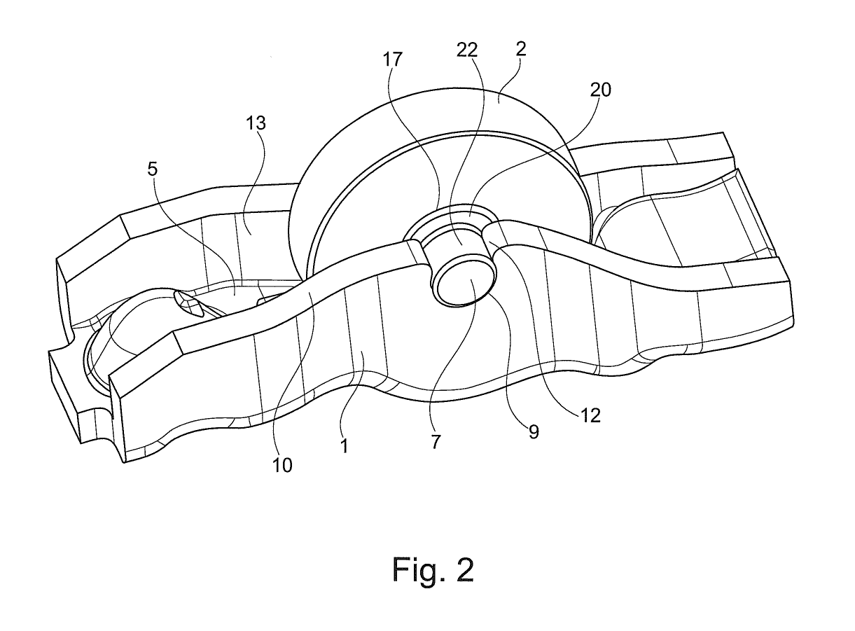

As can be seen from FIG. 2, areas of the longitudinal side 10 of the lateral wall 6 directly on both sides of each free peripheral segment 11 of the hole 9 are formed as flexible elastic projections 12. The pin 7 is installed by snapping the pin in from above behind the projections 12.

From FIG. 2 it can be further seen that the cam roller follower 2 is supported on a sliding bearing directly on the pin 7 by means of its hole 17. The latter pin 7 has, on both ends, a step 22 in its diameter, by means of which it is supported in the holes 9. A “step 22” is here to be understood as a diameter reduction. Ring projections 20 of the steps 22 run in front of the insides 13 of the lateral walls 6, so that the pin 7 is fixed in the axial direction. Instead of the stepped pin 7, this could also be provided without steps, wherein a separate ring is then pressed on in the middle for forming its step.

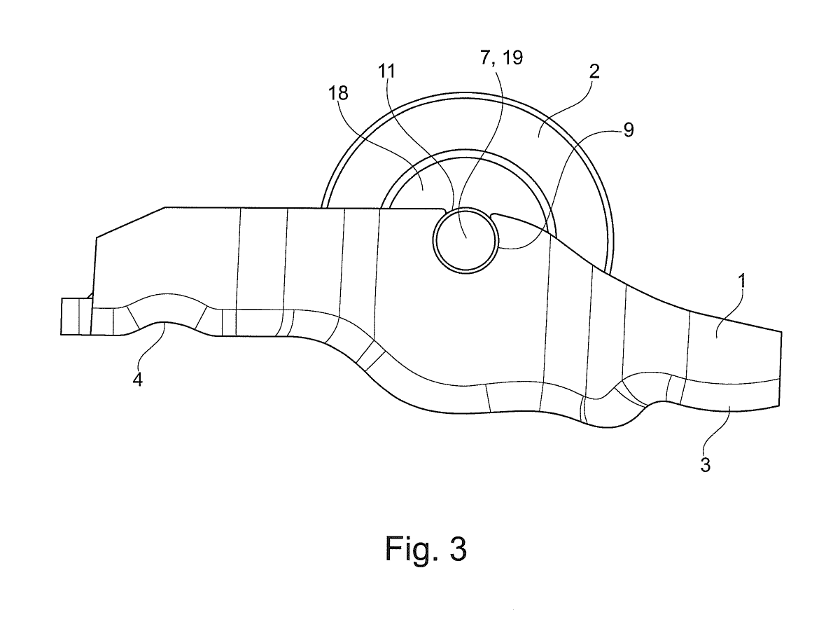

According to FIG. 3, the cam roller follower 2 is supported on the pin 7 by means of an intermediate ring 18. The needle bearing according to FIG. 1 is eliminated.

Due to the holes 9 that are open in the direction of the cam for the pin 7, it is possible to reduce the height of the lateral walls 6 from the cam side, so that greater access to the cam is possible as mentioned above.

### LIST OF REFERENCE NUMBERS

1) Cam follower

2) Cam roller follower

3) Structure

4) Support point

5) Transverse bar

6) Lateral wall

7) Pin

8) not assigned

9) Hole

10) Longitudinal side

11) Peripheral segment

12) Shoulder

13) Inner side

14) Needle bearing

15) Needle

16) Thrust washer

17) Hole

18) Intermediate ring

19) End side

20) Ring projection

21) Bottom side

22) Step

1. A lever-style cam follower for a valve train of an internal combustion engine, comprising a cam roller follower, a structure for contacting a gas exchange valve, and a support point for support against a cylinder head of the internal combustion engine, two lateral walls which are connected by a transverse bar and between which the cam roller follower is received, said cam roller follower being mounted on a pin that extends into holes in the lateral walls, each of the holes intersects, in some sections, a longitudinal side of a respective one of the lateral walls that faces the cam such that said pin lies with a peripheral segment exposed on said longitudinal side.

2. The cam follower according to claim 1, wherein each of the holes surrounds the pin by more than 180°.

3. The cam follower according to claim 2, wherein areas of the longitudinal side of the lateral wall lying directly on both sides of each of the exposed peripheral segments of the corresponding hole are formed as flexible elastic projections, with the pin being snapped in behind said projections.

4. The cam follower according to claim 2, wherein the pin has, on both ends thereof, a step in a diameter thereof by which the pin is supported in the hole, and ring projections of the steps run in front of inner sides of the lateral walls, fixing the pin in an axial direction.

5. The cam follower according to claim 4, wherein for forming the steps, the pin has a ring that is pressed onto a middle thereof with ends thereof forming the ring projections.

6. The cam follower according to claim 1, wherein the cam roller follower sits on the pin via an anti-friction bearing, needles of the bearing have no lateral walls in some sections in an area of the longitudinal side of the lateral wall facing the cam, and, for preventing loss, a thrust washer sitting on the pin between the lateral wall and the cam roller follower is used that covers the needles in a radial direction at least in some sections.

7. The cam follower according to claim 1, wherein the cam roller follower is supported directly on the pin via a hole through the cam roller follower.

8. The cam follower according to claim 1, wherein the cam roller follower is supported on the pin by an intermediate ring.

9. The cam follower according to claim 1, wherein the cam follower has a U-shaped, inverted U-shaped, or H-shaped cross section and is produced from sheet steel using either punching and bending techniques or extrusion molding techniques.

10. The cam follower according to claim 1, wherein the pin is through-hardened over an entire longitudinal extent thereof and end sides of the pin are expanded by radial point riveting.
